(19) United States
(12) Patent Application Publication
(10) Pub. No.: US 2010/0331084 A1
(43) Pub. Date: Dec. 30, 2010

(54) SYSTEM AND METHOD FOR A WRAP-AROUND GAMING EXPERIENCE

(75) Inventors: Skyler Fuzell-Casey, Reno, NV (US); Jacquelyn Fuzell, Reno, NV (US)

Correspondence Address: SILVERSKY GROUP LLC, 5422 LONGLEY LANE, SUITE B, RENO, NV, 89511, US

(73) Assignee: APERTURE INVESTMENTS LLC, Reno, NV (US)

(21) Appl. No.: 12/490,885

(22) Filed: Jun. 24, 2009

(51) Int. Cl. A63F 13/00

(52) U.S. Cl. 463/31

(57) ABSTRACT

A computer-based system and method for providing users of software/video games with a wrap-around gaming experience. A first game is played by a user in an initial form to gather experience. A second game is then played by the user to gather further experience. If the user gathers enough experience while playing the second game, the user can return to the first game and unlock features and experience that did not appear in its initial form, basically transforming the first game into a third game. A character and its attributes can also be exported from a first game into a second game with or without modifying the second video game.

### BRIEF DESCRIPTION OF THE INVENTION

The present invention is directed to a computer-based system and method for providing users of software/video games with a novel wrap-around experience. A first game is played by a user in an initial form to gather experience. A second game is then played by the user to gather further experience. If the user gathers enough experience while playing the second game, the user can return to the first game and unlock features and experience that did not appear in its initial form, basically transforming the first game into a third game. A character and its attributes can also be exported from a first game into a second game with or without modifying the second video game.

### CROSS-REFERENCES TO RELATED APPLICATIONS

Not applicable.

### STATEMENTS AS TO THE RIGHTS TO INVENTIONS MADE UNDER FEDERALLY SPONSORED RESEARCH OR DEVELOPMENT

Not applicable.

### REFERENCE TO A “SEQUENCE LISTING,” A TABLE, OR A COMPUTER PROGRAM LISTING APPENDIX SUBMITTED ON A COMPACT DISK

Not applicable.

### BACKGROUND OF THE INVENTION

Computer or video games are often structured to be played based on some sort of scripted plot with the point of achieving some goal or objective, whether it is to finish the game, collect the most objects or experience, or obtain the highest score. These games often have the players seeking to accomplish specific tasks, i.e., missions, or other structured objectives. Other games follow a sandbox type format where players may have tasks or objectives, but can also roam throughout the game environment and are free to choose which particular task or objective to fulfill in whatever order the player chooses to follow.

In general, such games represent either a single experience, meaning a game stands by itself and is not related to any other games, or a linear experience, meaning that a first game is followed by a second or more related game. In the linear experience, any objects, points or experience gained in the first game cannot be transferred to or used in the second game. It may be possible to save a player's progress during a game (including any collected objects, points, experience, etc.) in a storage system (RAM, hard-drive, or other storage device) connected to the gaming console (including a personal computer) running the game, but generally the stored information can only be used in that game, versus any other game. Further, once a game has been finished, it can be played again by starting over, with maybe a different outcome, but the game itself remains unchanged and the basic game experience is the same. This causes players to throw games away, leave them unused around the house, or even exchange them for other games in order to get a new game, which results in more plastic disks, cases, shrink-wrap and other unrecyclable materials being generated and furthering the destruction of the environment.

While it is common for games to share a common name or style of play, games are typically designed independently of each other. For example, a team of programmers and artists may be assigned to a game project, Game1, and once the project Game1 is finalized and released to the market, the original team is broken up and assigned to new projects, which may or may not be the sequel to said Game1. The problem is that video games end up sharing a common name, but the design and programming team may be different. The story ends up being different, and many aspects are changed in order to give the players a new and fresh gaming experience. While many players want a new and fresh gaming experience, they also like the characters of the previously played game and would like to continue their experience with those characters, including attributes that the characters may have developed over the course of their prior play.

While the market demands new and fresh gaming experiences, the market has also shown the success of sequels and prequels to popular games, including the MARIO BROS. games and sports games released every year such as MADDEN NFL 2002-2009 and NBA LIVE 95-09. Most of these games provide limited game play, an average of less than 20 hours, after which the player has the option to get a new game or start all over again, going through the same game experience. The exception to this are online games, such as WORLD OF WARCRAFT and SECOND LIFE, in which players can engage in contests, adventures, and social interactions through the game, thus allowing players to spend more hours than would be spent on an individual game because of the resulting interactions with other online players.

Another variation to games is multiple endings, which is a technique used to encourage more than one play-through a game. The majority of games that use multiple endings present a different ending based on the achievements completed by the player, or based on how the game was played. For example, an ending X would be shown at the end of a game if said game was completed in a very short amount of time, while an ending Y would be shown if all special missions were completed in the game. While players are encouraged to play the game more than once in order to see the alternate endings, the game experience is overall the same, except that a different set of goals are trying to be achieved. An alternative example is the game FABLE, in which the actions and decisions the player makes throughout the game influences the character's physical appearance, and ultimately whether the character becomes a hero or a villain. The player's decisions also affect how the other characters in the game react to the player's character. Nevertheless, the game experience is the same, with the exception being that the player chooses to follow a certain path along the game.

One way in which the content in a released video game can be modified is through the use of software “patches,” consisting of updates to the existing game content downloaded from an online server. These updates can range from bug fixes to adding new levels, maps, or weapons depending on the game type. A popular first-person shooter game, TEAM FORTRESS 2, makes use of this update feature to release new maps in which people can play, and by also providing a set of updates to the various game characters. These updates allow users to unlock weapons, but only after the players have met certain game play achievements. It is also common to have expansion packs to video games, which build on the game play and content of the original game and expand the game in various forms, including mentioned attributes such as new maps, new missions or campaigns, new storylines or new characters. Expansion packs tend to follow the storyline closely from the original game. The difference between expansion packs and software patches is that an expansion pack is sold as a game, while software patches are downloads automatically done when the game is started and which are usually downloaded free of charge. However, whether it is the case of expansion packs or software patches, these make global changes to the game content regardless of what the player might or might not have achieved in the game. Never does the experience and goals achieved by a player affect a second game.

The SONIC & KNUCKLES game released by SEGA for the GENESIS/MEGA DRIVE gaming platforms is another example of a hardware implementation that acted like an expansion pack. The SONIC & KNUCKLES game utilized the lock-on technology, which lets the SONIC & KNUCKLES cartridge and the gaming platform access data from the SONIC THE HEDGEHOG 2 and the SONIC THE HEDGEHOG 3 games. The SONIC & KNUCKLES game cartridge contained an open slot on the top, where the games could be inserted, locking on the SONIC & KNUCKLES cartridge. Any game for the GENESIS/MEGA DRIVE could be placed inside the SONIC & KNUCKLES game cartridge, but the only two compatible games were the SONIC THE HEDGEHOG 2 and the SONIC THE HEDGEHOG 3 games. The sharing of data enabled by the lock-on technology allowed for levels from the SONIC & KNUCKLES game, and the KNUCKLES character not originally available in the other SONIC games, to be used on the SONIC THE HEDGEHOG 2 and the SONIC THE HEDGEHOG 3 games. The lock-on cartridge of the SONIC & KNUCKLES game was designed knowing in advance the requirement for compatibility with the later SONIC games.

Yet another way in which the content in a released video game can be modified is through the use of a modification or a “mod.” A mod changes a released game, by either adding new content or by making a completely new game. Mods are typically made by independent developers or the general public. Many mods modify an original game into a completely different game, which only shares in common the engine with the original game. One of the most popular and commercially successful mods is the COUNTER-STRIKE mod to the HALF-LIFE game.

A player, who enjoys a game and finishes it, has the option to replay the game, but by doing so playing through the same events and gaming experience, which explains why it is common for players to discard games once they have finished a game. Game trading continues to grow because of this phenomenon. Further, creating a successful sequel to a game can also be a daunting task for game companies. For example, if gamers enjoy a game, they will come to have high expectations of related games based on their previous experience. Gaming companies capitalize on the success of previous game releases by using similar names on subsequent releases, but they do not capitalize on the countless hours spent by players on a video game. Hence, there is a need to be able to capture this personal gaming experience and use it to tie games together to enhance not only the game play, but also by allowing players to keep going back to previously played games they own, thus keeping games from being discarded and to use them as a means to constantly attract new players.

### BRIEF DESCRIPTION OF THE SEVERAL VIEWS OF THE DRAWING

FIG. 1 is a flow chart illustrating a high level overview of a method for checking a threshold of a game in order to modify a game based on a wrap-around gaming experience from a related game in accordance with an embodiment of the present invention; and

FIG. 2 is a flow chart illustrating a detailed method for modifying a game based on a wrap-around gaming experience in accordance with an embodiment of the present invention.

### DETAILED DESCRIPTION OF THE INVENTION

The present invention is directed to a novel type of gaming experience (referred to herein as “wrap-around” gaming or game experience) that enables a player to return to a previously played game, based on objects, points, experience, etc., gained in one or more subsequently played games, and to play the previously played game(s) as a new game. Each wrap-around game is designed to be played in three ways: (1) a basic experience; (2) a complex experience; and (3) a wrap-around experience.

To simplify matters from hereon, “game state” means some aspect of a status of the game that has been played, such as the player's progress, including achievements completed by the player, a period of time the game has been played, various levels that have been completed, various tasks or objectives that have been completed, etc. It will also refer to the game play experience, including actions taken, goals achieved and goals not completed, and events the player encounters while playing the game.

In the basic experience, a less experienced player (or one not interested in engaging in the complex experience) would play the game just for the fun of doing so, without necessarily collecting objects, points, experience or other items of any value. For example, if a game recreated a carnival environment, the basic player may be able to walk around the carnival grounds and experience the sights and scenario of an old fashioned carnival, with different games of skill or chance, rides, exhibits with barkers in front of tents encouraging the player's character to enter the tent, etc. If a player's character decided to play a game, for example, the character might have to pay some form of money to an attendant and then throw balls at a stack of old metal milk containers. If the character succeeded in knocking all of the containers down, the character might win a prize, or get their money back (or a small amount of additional money), or simply be able to play again.

Alternatively, the character might have to pay again just to play or there may be no charge to play in the first place—meaning the game is entirely for fun with no end result to be achieved, other than to just play the game. Characters could similarly participate in other aspects of the game, such as riding rides, like a Ferris wheel, entering tents to experience a house of mirrors, etc. Although a player can come back and play many times, nothing they do in basic or original mode changes the basic or original (out of the shrink wrapped box) experience of the game, based on the original source code shipped or provided with the game, or subsequently modified by bug fixes and/or updates (all of these being referred to herein as “original source code”). The basic/original experience is ideal for players who are interested in experiencing the environment of the game just to experience it, and nothing more.

The complex experience would be based on the same environment as the basic experience, but in this mode, the player's character would be attempting to achieve one or more goals or objectives while playing games. For example, in the recreated carnival environment game, this would involve riding rides, going through exhibits and moving around the carnival grounds. This may require the player to recognize clues, test different objects to see if they can be collected or used in some way, and attempt to do things that a player in basic mode would never do. The game may require the player to complete certain specified missions, or achieve some objective, or collect a certain amount of points to achieve new and different levels of play, etc. Depending on the structure of the game, a player's character would either “finish” the game (meaning that any assigned tasks, objectives, etc., had been achieved) or obtain some specified level of experience, points, money, etc., to become an “experienced character.”

Both the basic and complex experiences are common to many different types of existing games, but the wrap-around experience is not. In this mode, an experienced character returns to the previously played game, after they have finished the existing game or played one or more subsequent related games and reached some level of experience, points, objectives, etc. Upon returning to the start of the previously played game, the experienced character is subject to a sufficiently new game experience that the previously played game effectively becomes an entirely new game. In other words, the original, out of the box game is changed to such an extent that it becomes a different game, even though it may still be thematically related to the original game.

Taking the carnival experience as an example, if a character has played Game1 focused on Carnival X and has become an experienced character, the player would then move to Game2, which is focused on Carnival Y. After becoming an experienced character in Game2 or having achieved some particular goal, level, objective, point total, etc. in either Game1 or Game2, the player could then return to the start of Game1, but because the player is returning to Game1 in wrap-around mode, Game1 has now become Game3. In Game3, Carnival X might become Carnival Z, or Carnival X might become even more complex than it was before, with secret doors, passage ways, new experiences or even a completely different purpose than in Game1. In the wrap-around version, characters in Game1 could become completely different characters, or the personality of characters in Game1 could change, becoming evil or sinister for example. A game at Carnival X in Game1 that had some objective or resulted in some reward or outcome might be completely different in Game3. A tent housing the house of mirrors might house something completely different, or it might become possible to travel through the mirrors to other areas and adventures in Game3. Whatever the differences between Game1 and Game3, these differences would not become accessible or unlocked until a user had played Game2 and/or achieved some level, experience, status, etc., in Game2 or Game1.

The wrap-around mode requires that Game1 be developed in anticipation of becoming Game3 (or another game) after something has happened in Game1 or Game2. In the same manner, Game1 could be designed to become Game4 after a player has achieved some level, experience, status, etc., in Game5 or some other game. In other words, a game that includes a wrap-around feature becomes a kernel for the development of subsequent games. Thus, a previously played game could become one or more games once that game or a subsequent game has been played and the player has returned to the start of the previously played game.

Wrap-around mode also requires that players and/or characters and attributes regarding the player/characters, such as experience, points, objects collected and used, etc., be capable of being stored and used or transferred from one game to the next, or from the end of the first game to the start of the first game. This could be done a number of ways. A game could use the saved game state, which allows a player to save a game at a certain point, then start a different game and utilize at least some of the information saved from the prior game in the new game.

Realizing that some players may lack the patience or skill to complete the requirements necessary to turn Game1 into Game3, it might be possible for attributes to be purchased from other players, the game developer, or some other source, so a player can play Game3, based on having achieved the attributes necessary to convert Game1 into Game3.

As noted above, additional levels of complexity could also be developed with Game1 being converted into Game4 after Game5, but it might also be possible for Game2 to become Game6 after Game3 or some other game. The manner in which games could wrap-around one another does not have to follow a linear progression. For example, a player can play Game1, then play Game2, and go back to play Game1 before playing Game3 or Game4. Thus, the wrap-around between games is almost limitless. Furthermore, wrap-around games could be structured to be modifiable through downloaded features, scenarios, characters, themes and other items. For example, once a user has reached some objective in a current game or a subsequent game, the player could return to an earlier point in the present game or return to a previously played game and get the ability to go to a website and download data that will enable Game1 to be transformed into a separate game, or to develop other features or abilities.

Every wrap-around game is designed to be a kernel that enables the development of further games upon completion of some threshold point in a current game or upon the play of a subsequent game, whether through the result of previously stored content in one wrap-around game or as a result of additional data being downloaded to modify the wrap-around game. The net effect is a “greener” gaming development platform that allows players to experience many different games without throwing away the old game or exchanging it for a new one once they have finished or completed the game or some aspect of the game or every time a new game is offered. Thus, players can keep games and get further value and pleasure from the games once additional attributes have been achieved in other games.

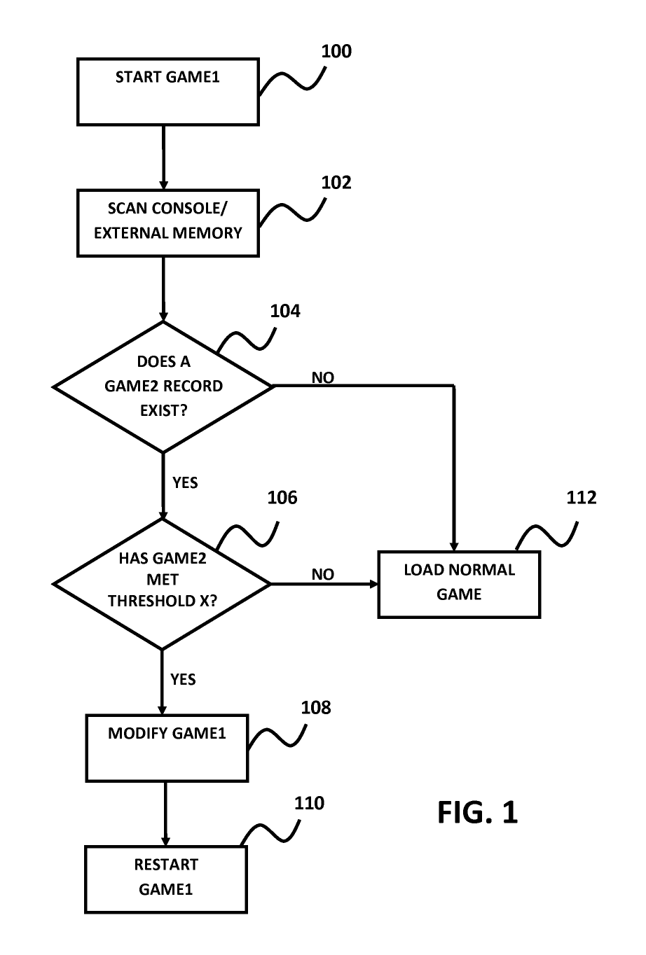

FIG. 1 illustrates a flow chart of a high level overview of how to modify Game1 by the wrap-around from the Game2 experience according to an embodiment of the present invention. Game1 is started and loaded in step 100. Game1 then scans either the console, computer hard drive, or any external storage system attached to said console or computer for specific game state files, step 102. Where a file or record from a different but related game is found, for example Game2, that record is analyzed to determine the level of game play or experience completed in Game2, step 104. Step 106 checks if a specified threshold of game play or experience has been reached in Game2, which would ideally be specified and coded into the game, but which may be varied by software patches, then Game1 would be modified in step 108 according to a predetermined program stored as part of Game1 (or based on a download that would occur at that time), such as by adding new levels, adding new characters, adding alternative story lines, etc. Since the methods that will be used to modify the game and the attributes of the game to be modified will depend on the game, the game type and genre, the game company, hardware and software limitations, etc., it is not possible, realistic or necessary to attempt to explain all of those methods and attributes in this description. Moreover, it is not necessary to describe such methods or attributes herein because anyone of skill in the art of the present invention will be able to implement such functionality. After Game1 has been modified, Game1 is restarted, step 110. If a record for Game2 does not exist in step 104, or if the threshold has not been met in step 106, then Game1 is loaded normally without any modifications in step 112.

A similar technique could be used to modify Game1 based on a certain threshold being achieved by a player in Game1. For example, if a player had completed Game1 and established a certain level of experience, points, prizes, weapons, etc., the player might be given the option of restarting Game1 and replaying the game based on the certain level achieved. Game1 could then be exactly the same as it had been the first time it was played, but played differently because of the certain level achieved. Alternatively, Game1 could be altered in some way to account for the certain level achieved so the experience of Game1 is different the second time around. Likewise, Game1 could also become Game2 as a result of the wrapped-around experience. Such features would be implemented in the same fashion as illustrated in FIG. 1, with Game1 scanning for records/files indicating that a threshold has been achieved and then modifying the game based on that threshold. If the programmers of Game1 thought far enough in advance during the programming of Game1 to incorporate, but hide, modifications necessary to create a Game2, then the code needed to implement the modifications for Game2 could be stored with the code that originally implemented Game1 and unlocked at a later point in time. Alternatively, the code needed to implement Game2 could be downloaded at that time (after confirmation of the threshold being reached).

The threshold specified above can be based on a variety of methods. An example is to use a character's experience points or level as the threshold value, so that once a character has reached X experience points in Game2, the player can go back and replay Game1, but this time with the modified storyline, game play, etc. More advanced logic can also be used instead of the simple threshold value check. Out of all achievable goals that can be completed in a game, say Game2, the specific subset of goals achieved by a player in Game2 could directly affect how the original Game1 is modified. Assuming that the user completes goals A, B, and E in Game2, it could result in Game1 being modified into Game3, while completing goals C, F, and G could result in Game1 being modified into Game4. Thus creating many possibilities for the game design team to explore and providing players with further entertaining game play.

When a video game, Game1, tries to analyze the saved record from a subsequent but related game, Game2, it can be done by having a common game save format used by the games. Alternatively, a standard saving can be devised, which allows for the saved game data between games to be analyzed or shared. If Game1 saves the data in a custom format, Format1, which is different from the custom format used in Game2, Format2, the data from Format1 and Format2 can be converted into a standard intermediary format, SHAREDFORMAT, thus allowing for data compatibility between games when data from a different game needs to be imported into the currently running game.

In the preferred embodiment of the present invention, when a video game is initially loaded into the gaming console, the memory or storage system of the gaming console or any attached external memory device is scanned to read the recorded saved game states for the current game and for games which share a similar saved game state format, ideally subsequent but related video games. If the game state is past a threshold, as specified above, Game1 is converted to Game3 or Game4, etc. In a manner similar to how a game can be switched from an easy difficulty level to a hard or expert difficulty level, a game can also be switched to Game3 game play, based on the player's experiences on other games. The difference is that when the difficulty level is changed in a game, typically these results involve changing attributes such as time limit, the number of enemies, the resilience of enemies, etc. In a wrap-around game, the conversion from Game1 to Game3 results in changes to the game play experience on a large scale, such as by modifying the storyline, making the original game feel like a completely different game, in contrast to making a game feel the same, but with more difficult opponents.

The additional game content, which constitutes Game3, can be programmed in the original CD or DVD. Alternatively, in cases where the game content is large, or when the additional Game3 content is intentionally left unspecified until after the development of games subsequent to Game1, the instruction to modify the original Game1 could trigger an automatic software patch download from an online server, which would download the new content, effectively converting Game1 into Game3.

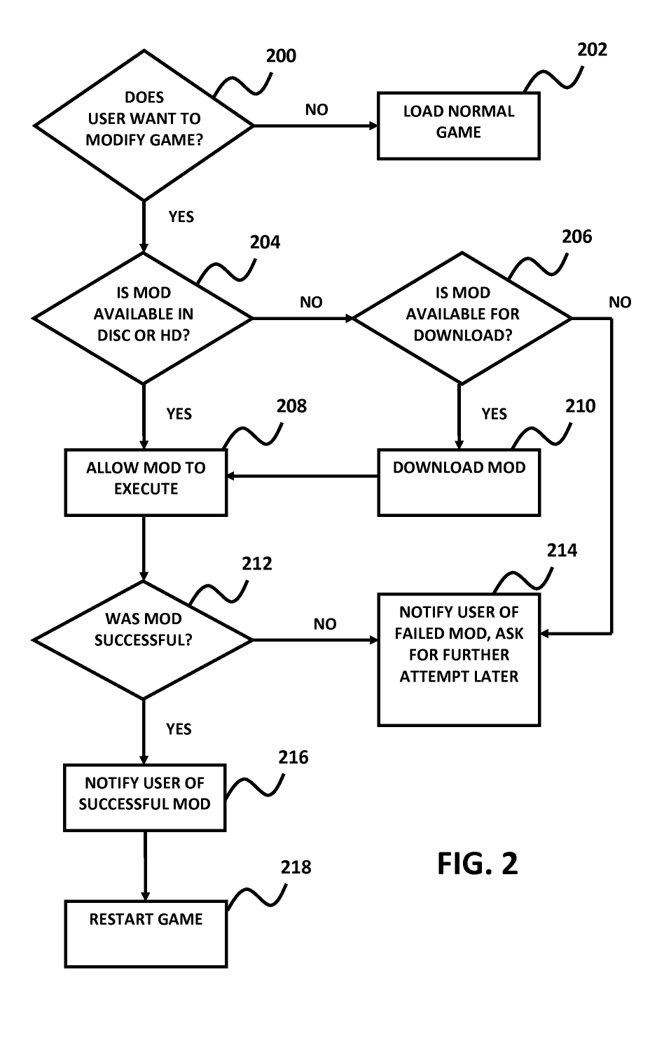

FIG. 2 illustrates an example flowchart of how Game1 can be modified, with respect to an embodiment of the present invention, once it has already been determined that a record for Game2 exists and that the Game2 record has met the specified threshold. Step 200 checks to see if the user wishes to modify the current game, Game1. If the user does not want to modify Game1 based on the wrap-around gaming experience, then the game is loaded normally without any modifications applied, step 202. If the user wants to modify Game1 based on the wrap-around gaming experience, then step 204 checks to see if the module for modifying the game from the wrap-around experience is available in the game disc, in the gaming console's hard drive, or any external storage system attached to the gaming console. If this module is available locally, then the module is executed in step 208. If the module is not available locally (disc, hard drive, or external storage system), then the game checks whether the module is available on a server online, step 206. If the module is available for download, then the module is downloaded and stored locally in step 210 and allowed to execute in step 208. Otherwise, if the module is not available for download (for example, the server could be down), the user is notified that the module failed to download and modify the game, and the user is asked to reattempt the wrap-around modification at a later time, step 214.

Once the module has finished executing, the result of the module's execution is checked in order to verify whether the module successfully modified the game, or if the module failed to complete due to an exception error, step 212. The execution of the module can fail due to a variety of reasons, including but not limited to corrupt memory, corrupt program instructions, process deadlock, running out of memory or disk space, etc. The user is notified of a failed modification in step 214, while the successful modification of the game is notified to the user in step 216. Finally, step 218 restarts the game in order to load the new modified game.

In an embodiment of the present invention, a player will be able to export a character and all of the attributes of that character from one game into a different game, even if that character was not originally a character in the different game. This will allow the player to play a game with a character, gather experience with that character, and then take that character, with all of its attributes, and play a second game with all of the attributes from the first game. An example of this would be the player playing a game, GameX, using a character, CharacterA. The player would then be able to take CharacterA from GameX, and export it so that it can be loaded in a different game. The exported CharacterA can then be imported into a different game, GameY. When the player exports CharacterA from GameX, with all associated attributes, to GameY, if the attributes of CharacterA are supported by GameY, they may be available to the player in GameY. If the attributes are not supported, or would be inappropriate, then some or all of those attributes might be reduced to a subset or completely removed based on the support for or appropriateness of the attributes of CharacterA in GameY. For example, if GameX takes place in a modern setting, and GameY takes place in a medieval setting, then all of the weapon attributes of CharacterA might be removed. Alternatively, only the melee weapons would be imported into GameY. In yet another embodiment, the player plays GameX, exports CharacterA from GameX with all associated attributes to GameY, with GameY playing in a different manner based on the attributes of CharacterA.

Using the same modern versus medieval game setting example, when exporting the CharacterA with all its attributes from GameX with the modern setting into GameY with the medieval setting, GameY could be modified so that the medieval GameY characters possess magic which can allow them to engage in combat with CharacterA possessing modern weapons and experience points from GameX. Alternatively, the characters in GameY could also develop new modern weapons or other aspects of the game would change because of the changes introduced by the import of CharacterA. The manner in which a game is modified will depend on the game, the game type and genre, the game company, hardware and software limitations, and target audience, as well as the character and the set of attributes imported into the game. All of these factors give game developers many possibilities for creating game modifications.

The exporting of a character from a game into a different game can be done using a similar approach to game state exporting, as previously discussed herein. In one embodiment of the present invention, the player selects a character to be exported, with a screen subsequently presented which allows the player to save the character to a file, similar to how game progress is saved to files in video games. Alternatively, the game can autosave the character to a file as the game progresses.

The methods that will be used to save the set of character attributes will depend on the game, the game type and genre, the game company, hardware and software limitations, etc. At a high level, the set of character attributes can consist of a set of experience points, a list of missions completed, items or weapons collected, etc. At a lower level, the set of character attributes can include the geometry of the character, a set of instructions for rendering the character, a set of transformations to apply to the geometry of the character, a set of shaders and textures for rendering the character, etc.

The importing of a character into a game from a different game can be done using a similar approach to game state importing when modifying a game based on the wrap-around experience of a different game, as previously discussed herein. In one embodiment of the present invention, the player can select a game file to load, and subsequently be presented with a set of characters that can be used to play the loaded game file. These characters can be original game characters, or they can be characters exported from different games. Alternatively, the player can choose the character to use, be it an original character or an exported character from a different game, and then select a game file to load. In yet another embodiment of the present invention, the player loads a game file, and once the game has been loaded, the user can switch between characters during the gameplay. For example, a player can choose to use an original character of the game while visiting towns, and switch to the exported character from a different game when playing in dungeons.

Alternatively, the exporting and importing of a character between two different games can be automated. For example, the player plays GameX using CharacterA, then plays GameY. When GameY is being loaded, the player is asked to choose a character to use for the entire GameY. The player can then be given the option to choose an original character from GameY, or the player can choose to import CharacterA exported from GameX. Once this selection has been finalized, the user can play GameY, using CharacterA, with progress in the GameY autosaved to a file. The user can then alternate between GameX and GameY, with CharacterA progress in both GameX and GameY reflected when playing each respective game.

In yet another embodiment of the present invention, the game data from two or more games could be combined to allow a player to experience characteristics from each game. For example, if two different games were released that take place in a STAR WARS universe, then the user would be able to combine the two software games into a third game, that would allow a player to use characters from either game in the third game, or that would allow a player to play levels which are a combination of levels from the combined games. However, the two games do not necessarily need to have a common framework or a common theme. A STAR WARS game could be combined with the game data from a SONIC game, to allow the SONIC character to explore a STAR WARS level, or allow the SONIC character to face boss characters and enemies from the STAR WARS game, or vice versa.

Plug-ins could be written for each game that allow for data related to characters, skills, and levels to be exported into a shared or intermediary format. Once the data from two or more games has been converted, if necessary, into the intermediary or shared format, then the data from the two games could be combined based on a variety of methods or rules. For example, one manner in which the data from two games could be combined would be by allowing the playable characters from the two or more games to be used in either game. Another combination rule would create new levels, by combining characteristics from the two or more games. If one game revolved around completing levels by avoiding obstacles and enemies, while the game play from the second game revolved around solving puzzles, then a combined level could allow a player to avoid obstacles and enemies up to a point, presenting a set of puzzles in order to advance further in the level, or presenting the user the option to go through an additional set of obstacles and enemies if the puzzle cannot be solved.

The manner in which two or more games are combined is almost limitless, and will depend on the games being combined, their corresponding game types and genres, the game companies that made each of the games, hardware and software limitations, etc. The key aspect for the game data from two games to be successfully combined is for the game data from two games, possibly using incompatible game formats, to be able to convert data from the game, that can be used for combination with other games, into an intermediary or standard format, for the combined game to be able to operate and access the data from the two or more games.

A problem with any software project is architectural degradation due to adding new features or functionality which were not originally envisioned by the software architects of the game. The choice of software architecture to use for wrap-around games will depend on the target gaming console and the game requirements. While it is up to the game designers to choose a proper architecture in order to support the continuous addition and modification of the original game content to support the wrap-around gaming experience, design patterns can be used which can mitigate architectural degradation in the game software. The design pattern or patterns that can be used could vary significantly. The key is to use any design pattern or combination thereof necessary to implement a stable and robust software architecture that will support the continuous software updates and maintenance.

The present invention, while illustrated and described in terms of a preferred embodiment and several alternatives, is not limited to the particular description contained in this specification. Additional alternative or equivalent components and steps could be used to practice the present invention.

What is claimed is:

1. A method of providing a wrap-around gaming experience in a computer system, comprising the steps of:
allowing an entity to play a first video game on the computer system, the first video game operating on the computer system in an original manner;
allowing the entity to play a second video game on the computer system;
recording a game state for the second video game at one or more periods of time during the entity's play of the second video game; and
modifying the first video game so as to cause it to operate on the computer system in a different manner based on the game state rather than the original manner.

2. The method as recited in claim 1, wherein the step of recording the game state includes the step of recording the game state in a format that can be read by the first video game.

3. The method as recited in claim 1, wherein the step of recording the game state includes the step of recording the game state in a format, and wherein the step of modifying the first video game includes the step of converting the game state from the format to a second format that can be read by the first video game.

4. The method as recited in claim 1, wherein the step of modifying the first video game is triggered by a threshold.

5. The method as recited in claim 4, wherein the step of modifying the first video game includes the steps of:
(a) searching for the game state;
(b) analyzing the game state to determine if the threshold has been met; and
(c) modifying the first video game to operate in the different manner if the threshold has been met.

6. The method as recited in claim 5, wherein step (b) includes the step of converting the game state to a format that can be read by the first video game.

7. The method as recited in claim 5, wherein step (c) includes the step of enabling a set of features associated with the first video game that cause the first video game to operate in the different manner.

8. The method as recited in claim 5, wherein step (c) includes the step of downloading from one or more sources a set of features associated with the first video game that cause the first video game to operate in the different manner.

9. The method as recited in claim 5, wherein the computer system includes a storage system and wherein step (c) includes the step of executing a module located on the storage system or located on a first video game disc that causes the first video game to operate in the different manner.

10. The method as recited in claim 5, wherein the computer system includes a storage system and wherein step (c) includes the step of executing a module downloaded from one or more sources and subsequently stored in the storage system that causes the first video game to operate in the different manner.

11. The method as recited in claim 5, wherein step (c) includes the step of adding one or more from the group of a new map, a new weapon, a new character, a new mission, a new level, a new storyline, a modification to an existing map, a modification to an existing weapon, a modification to an existing character, a modification to an existing mission, a modification to an existing level, or a modification to an existing storyline.

12. The method as recited in claim 4, wherein the threshold is coded into an original source code of the first video game.

13. The method as recited in claim 4, wherein the threshold can be set or modified by executing a module downloaded from one or more sources.

14. The method as recited in claim 4, wherein the threshold is achieved by completing a series of goals in the second video game.

15. The method as recited in claim 4, wherein the threshold is achieved by purchasing one or more threshold points from one or more sources.

16. The method as recited in claim 1, further comprising the step of enabling the entity to override the step of modifying the first video game.

17. The method as recited in claim 1, wherein the first video game and second video game are selected from the group of stand-alone games and games played over a network.

18. The method as recited in claim 1, wherein the first video game is modified based on a second game state of one or more subsequent but related games.

19. A method of providing a wrap-around gaming experience in a computer system, comprising the steps of:
allowing an entity to play a video game on the computer system, the video game operating on the computer system in an original manner;
recording a game state for the video game at one or more periods of time during the entity's play of the video game; and
modifying the video game so as to cause it to operate on the computer system in a different manner based on the game state than the original manner.

20. The method as recited in claim 19, wherein the step of modifying the video game is triggered by a threshold.

21. The method as recited in claim 20, wherein the step of modifying includes the steps of:
(a) searching for the game state;
(b) analyzing the game state to determine if the threshold has been met; and
(c) modifying the video game to operate in the different manner if the threshold has been met.

22. The method as recited in claim 21, wherein step (c) includes the step of enabling a set of features associated with the video game that cause the video game to operate in the different manner.

23. The method as recited in claim 21, wherein step (c) includes the step of downloading from one or more sources a set of features associated with the video game that cause the video game to operate in the different manner.

24. The method as recited in claim 21, wherein the computer system includes a storage system and wherein step (c) includes the step of executing a module located on the storage system or on a video game disc that causes the video game to operate in the different manner.

25. The method as recited in claim 21, wherein the computer system includes a storage system and wherein step (c) includes the step of executing a module downloaded from one or more sources and subsequently stored in the storage system that causes the video game to operate in the different manner.

26. The method as recited in claim 21, wherein step (c) includes the step of adding one or more from the group of a new map, a new weapon, a new character, a new mission, a new level, a new storyline, a modification to an existing map, a modification to an existing weapon, a modification to an existing character, a modification to an existing mission, a modification to an existing level, or a modification to an existing storyline.

27. The method as recited in claim 20, wherein the threshold is coded into an original source code of the video game.

28. The method as recited in claim 20, wherein the threshold can be set or modified by executing a module downloaded from one or more sources.

29. The method as recited in claim 20, wherein the threshold is achieved by completing a series of goals in the video game.

30. The method as recited in claim 20, wherein the threshold is achieved by purchasing one or more threshold points from one or more sources.

31. The method as recited in claim 20, further comprising the step of enabling the entity to override the step of modifying the video game.

32. The method as recited in claim 19, wherein the video game is selected from the group of stand-alone games and games played over a network.

33. A video game system for use on a computer system including a storage system, comprising:
an original video game for use on the computer system, the original video game including an original source code for causing the original video game to operate in a specific manner;
a second video game for use on the computer system, the second video game including a game state recorded in the storage system; and
a third video game for use on the computer system, the third video game being created by modifying the first video game based on the game state to operate in a second manner that is different from the specific manner.

34. The video game system as recited in claim 33, wherein the second manner includes a feature selected from the group of a new map, a new weapon, a new character, a new mission, a new level, a new storyline, a modification to an existing map, a modification to an existing weapon, a modification to an existing character, a modification to an existing mission, a modification to an existing level, or a modification to an existing storyline.

35. The video game system as recited in claim 33, wherein the second manner is thematically related to the specific manner.

36. The video game system as recited in claim 33, wherein the third video game is created by downloading a set of code from one or more sources to the storage system, the set of code operating to modify the first video game to create the third video game, the set of code being downloaded based on the game state.

37. The video game system as recited in claim 33, wherein the third video game is created by unlocking a set of code stored on the storage system that operates to modify the first video game to create the third video game, the set of code being unlocked based on the game state.

38. A video game system for use on a computer system including a storage system, comprising:
an original video game for use on the computer system, the original video game including an original source code for causing the original video game to operate in a specific manner, the original video game including a game state recorded in the storage system;
a second video game for use on the computer system, the second video game being created by modifying the first video game based on the game state to operate in a second manner that is different from the specific manner.

39. The video game system as recited in claim 38, wherein the second manner includes a feature selected from the group of a new map, a new weapon, a new character, a new mission, a new level, a new storyline, a modification to an existing map, a modification to an existing weapon, a modification to an existing character, a modification to an existing mission, a modification to an existing level, or a modification to an existing storyline.

40. The video game system as recited in claim 38, wherein the second manner is thematically related to the specific manner.

41. The video game system as recited in claim 38, wherein the second video game is created by downloading a set of code from one or more sources to the storage system, the set of code operating to modify the original video game to create the second video game, the set of code being downloaded based on the game state.

42. The video game system as recited in claim 38, wherein the second video game is created by unlocking a set of code stored on the storage system that operates to modify the original video game to create the second video game, the set of code being unlocked based on the game state.

43. A method of allowing a video game character to be exported from a first video game and imported into a second video game in a computer system, comprising the steps of:
allowing an entity to play a first video game on the computer system using a first character;
recording a set of character attributes related to the first character at one or more periods of time during the entity's play of the first video game;
exporting the first character and the set of character attributes from the first video game;
importing the first character and the set of character attributes to a second video game, the second video game operating in an original manner; and
allowing the entity to play the second video game on the computer system, using as a character of the second game the first character from the first video game with the set of character attributes.

44. The method as recited in claim 43, further comprising the step of modifying the second video game so as to cause it to operate on the computer system in a different manner than the original manner based on the set of character attributes related to the first character.

45. The method as recited in claim 44, wherein the computer system includes a storage system wherein the step of recording includes storing the set of character attributes in the storage system; and wherein the steps of exporting and importing include the steps of:
(a) searching for the set of character attributes related to the first character in the storage system;
(b) analyzing the set of character attributes related to the first character; and
(c) modifying the second video game to enable the second video to use a subset of the set of character attributes related to the first character in the second video game.

46. The method as recited in claim 45, wherein step (b) includes the step of converting the set of character attributes related to the first character to a format that can be read by the second video game.

47. The method as recited in claim 45, wherein the subset causes the second video game to operate in the different manner.

48. The method as recited in claim 45, further comprising the step of downloading from one or more sources a set of features associated with the second video game based on the subset that causes the second video game to operate in the different manner.

49. The method as recited in claim 45, wherein step (c) includes the step of executing a module located on the storage system or on the second video game disc that causes the second video game to operate in the different manner.

50. The method as recited in claim 45, wherein step (c) includes the step of executing a module downloaded from one or more sources and subsequently stored in the storage system that causes the second video game to operate in the different manner.

51. The method as recited in claim 45, wherein step (c) includes the step of adding one or more from the group of a new map, a new weapon, a new character, a new mission, a new level, a new storyline, a modification to an existing map, a modification to an existing weapon, a modification to an existing character, a modification to an existing mission, a modification to an existing level, or a modification to an existing storyline.

52. The method as recited in claim 43, wherein the step of exporting includes the step of recording the set of character attributes related to the first character in a format that can be imported and read by the second video game.

53. The method as recited in claim 43, wherein the step of exporting includes the step of recording the set of character attributes related to the first character in a format, and wherein the step of importing includes the step of converting the set of character attributes related to the first character from the format to a second format that can be read by the second video game.

54. A method of combining first game data from a first video game with second game data from a second video game, comprising the steps of:
reading first game data from the first video game;
if necessary converting first game data from the first video game into a shared format;
reading second game data from the second video game;
if necessary converting second game data from the second video game into the shared format;
combining first game data and second game data to make at least a portion of third game data for a third video game; and
allowing an entity to play the third video game based on third game data.

55. The method as recited in claim 54, wherein the third game data consists of one or more from the group of: a combination of one or more characters from the first video game and the second video game;
a combination of one or more levels from the first video game and the second video game; a combination of one or more sets of attributes from the first video game and the second video game; and a combination of one or more story lines from the first video game and the second video game.
